(19) United States
(12) Patent Application Publication
(10) Pub. No.: US 2025/0355182 A1
(43) Pub. Date: Nov. 20, 2025

(54) Cable Slitter

(71) Applicant: Milwaukee Electric Tool Corporation, Brookfield, WI (US)

(72) Inventors: Michael Heggen Inouye, Pewaukee, WI (US); Tamanna Tasnim, Brown Deer, WI (US)

(21) Appl. No.: 19/173,168

(22) Filed: Apr. 8, 2025

Related U.S. Application Data
(60) Provisional application No. 63/649,660, filed on May 20, 2024.

(51) Int. Cl. G02B 6/245; H02G 1/12

(52) U.S. Cl. CPC G02B 6/245; H02G 1/1221

(57) ABSTRACT

A cutting tool for a cable jacket is provided. The cutting tool includes a housing and a blade tip. The housing includes a first section and a second section coupled together via a pivot joint. The first section and the second section are rotatable with respect to a pivot axis defined by the pivot joint between a closed position and an opened position. When in the closed position, the first section and second section define a through-hole centered on and extending along a longitudinal axis. The pivot joint is offset to a side of the through-hole, and the longitudinal axis is oriented at a non-zero angle with respect to the pivot axis. The blade tip is positioned within the through-hole and is configured to cut a cable jacket located within the through-hole.

### CROSS-REFERENCE TO RELATED PATENT APPLICATION

The present application claims the benefit of and priority to U.S. Provisional Application No. 63/649,660 filed on May 20, 2024, which is incorporated herein by reference in its entirety.

### BACKGROUND OF THE INVENTION

The present disclosure is directed generally to the field of tools. The present disclosure relates specifically to a cable slitting tool designed to slit or cut the exterior sheath of a cable.

### SUMMARY OF THE INVENTION

One embodiment of the invention relates to a cutting tool for a cable jacket. The cutting tool includes a housing and a blade tip. The housing includes a first section, a second section, and a pivot joint. The first section defines a first recessed surface extending along the first section from a first end of the first section to a second end of the first section opposite the first end. The second section defines a second recessed surface extending along the second section from a third end of the second section to a fourth end of the second section opposite the third end. The pivot joint couples the first section to the second section. The pivot joint is centered on a pivot axis. The first section and the second section are rotatable with respect to the pivot axis between a closed position and an opened position. When in the opened position, the first section is positioned at an angle with respect to the second section. When in the closed position the first recessed surface and the second recessed surface define a through-hole centered on and extending along a longitudinal axis. The pivot joint is offset to a side of the through-hole and the longitudinal axis is oriented at a non-zero angle with respect to the pivot axis. The blade tip is positioned within he through-hole and is configured to cut a cable jacket located within the through-hole.

Another embodiment of the invention relates to a cable slitter. The cable slitter includes a first section, a second section, and a through-hole. The first section includes a first end, a second end opposite the first end, a first blade positioned between the first end and the second end, and a slot defined in the second end. The second section includes a third end, a fourth end opposite the third end, a second blade positioned between the third end and the fourth end, and a protrusion extending away from the fourth end of the second section. The protrusion of the second section is received within the slot of the first section and is retained within the slot via a pivot pin. The pivot pin defines a pivot axis. The through-hole is defined between the first section and the second section. The through-hole extends along and is centered on a longitudinal axis. The longitudinal axis is oriented at a non-zero angle with respect to the pivot axis.

Another embodiment of the invention relates to a cutting tool. The cutting tool includes a first section, a second section, a through-hole, and a blade tip. The first section includes a first channel extending along the first section from a first end to a second end opposite the first end. The second section includes a second channel extending along the second section from a third end to a fourth end opposite the third end. The second section is pivotally coupled to the first section via a pivot joint. The pivot joint is centered on a pivot axis. The first section and the second section are rotatable with respect to the pivot axis between a closed position and an opened position. The through-hole is defined by the first channel and the second channel when the first section and second section are in the closed position. The through-hole is centered on and extends along a longitudinal axis. The pivot axis is oriented in a direction perpendicular to the longitudinal axis. The blade tip extends through an inner surface of the through-hole and is configured to cut a workpiece positioned in the through-hole.

Additional features and advantages will be set forth in the detailed description which follows and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a front side view of a cable slitter, according to an exemplary embodiment;

FIG. 2 is a rear side view of the cable slitter of FIG. 1, according to an exemplary embodiment;

FIG. 3 is a front perspective view of the cable slitter of FIG. 1 from below, according to an exemplary embodiment;

FIG. 4 is a front perspective view of the cable slitter of FIG. 1 from a left side, according to an exemplary embodiment;

FIG. 5 is a front perspective view of the cable slitter of FIG. 1 from a right side, according to an exemplary embodiment;

FIG. 6 is a detail view of a pivot joint of the cable slitter of FIG. 1, according to an exemplary embodiment;

FIG. 7 is a perspective view of the cable slitter of FIG. 1 in a partially opened position, according to an exemplary embodiment;

FIG. 8 is a perspective view of the cable slitter of FIG. 1 in an opened position, according to an exemplary embodiment;

FIG. 9 is a top view of the cable slitter of FIG. 1 in an opened position, according to an exemplary embodiment;

FIG. 10 is an exploded view of a blade housing of the cable slitter of FIG. 1, according to an exemplary embodiment;

FIG. 11 is a detail exploded view of the blade housing of the cable slitter of FIG. 1, according to an exemplary embodiment;

FIG. 12 is a cross-sectional view of the cable slitter of FIG. 1, according to an exemplary embodiment;

FIG. 13 is a detail view of a through-hole of the cable slitter of FIG. 1, according to an exemplary embodiment;

FIG. 14 is a detail view of a through-hole of the cable slitter of FIG. 1, according to an exemplary embodiment; and

FIG. 15 is a front side view of the cable slitter of FIG. 1 being held by a user, according to an exemplary embodiment.

### DETAILED DESCRIPTION

Referring generally to the figures, various embodiments of a cutting tool for a cable jacket, such as cable slitters used to cut or slit the jacket of fiber optic drop cables, are provided with various features to improve functionality and/or ease of use. Some conventional cable slitters include a pivot joint that connects portions of the cable slitter housing on multiple sides of a cable-receiving through-hole. In some embodiments, the cable slitter described herein includes a pivot joint that is offset entirely to one side of a central cable-receiving through-hole with respect to a pivot axis of the pivot joint. In contrast to some conventional cable slitters, the cable slitter described herein provides access to the cable-receiving through-hole along a side opposite the pivot joint, allowing a cable to be placed into the cable slitter at both an end of the cable and a mid-span location on the cable. In further embodiments, the pivot joint is configured to open through an angle of 120 degrees or more, further enhancing the ease with which a mid-span portion of a cable can be placed within the cable slitter.

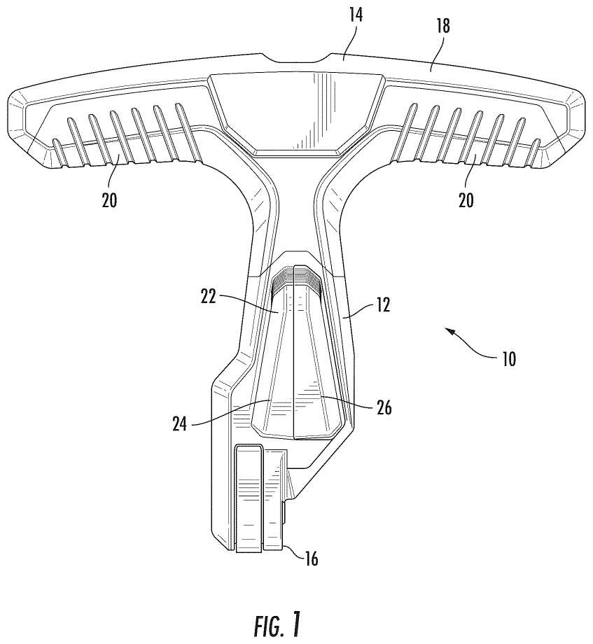

Referring to FIG. 1, a front side of a cable jacket cutting tool, such as cable slitter 10, is shown, according to an exemplary embodiment. Cable slitter 10 includes a housing 12 having a first end 14 and a second end 16. Housing 12 includes a handle 18 having two grip sections 20 on opposing sides of first end 14. In some embodiments, housing 12 is formed from a plastic material through an injection molding process. In a specific embodiment, grip sections 20 are formed from a second, different polymer material via overmolding onto the plastic material that forms handle 18. Grip sections 20 include a plurality of ridges to provide a gripping surface and increase friction between handle 18 and a user's hand.

Cable slitter 10 also includes a plurality of blade housings 22 formed from a first blade housing shell 24 and a second blade housing shell 26. In a specific embodiment, at least one of first blade housing shell 24 and second blade housing shell 26 are integrally formed with housing 12 such that the first blade housing shell 24 or the second blade housing shell 26 forms a single continuous, contiguous piece with a portion of housing 12.

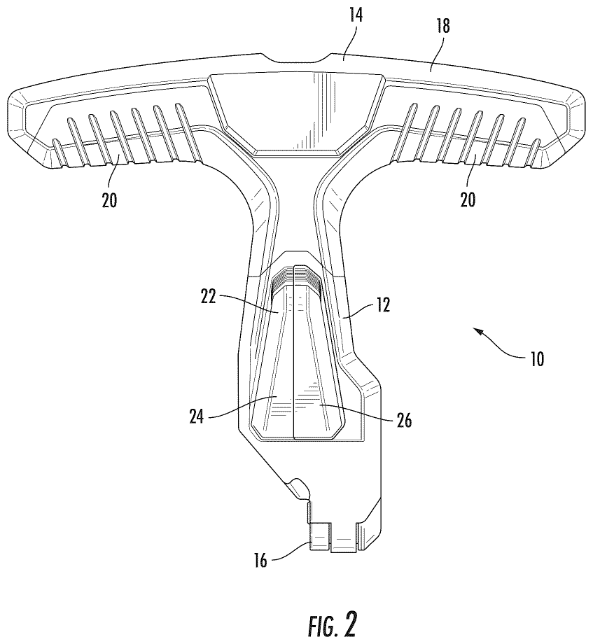

Referring to FIG. 2, a rear side of cable slitter 10 is shown, according to an exemplary embodiment. The rear side of cable slitter 10 also includes a blade housing 23 that is substantially similar to blade housing 22 located on the front side of cable slitter 10 in FIG. 1. As shown in FIG. 2, grip sections 20 extend around the rear side of handle 18.

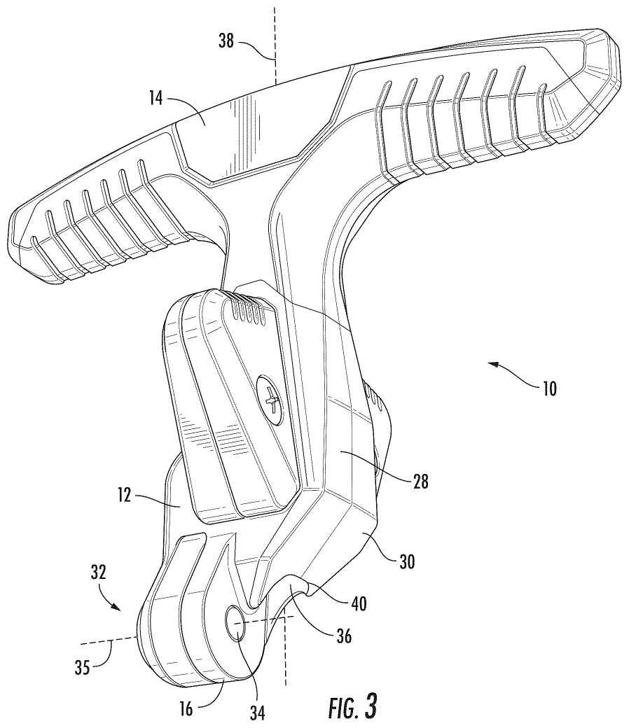

Referring to FIG. 3, a perspective view of cable slitter 10 is shown from below, according to an exemplary embodiment. Housing 12 is formed from a first housing section 28 and a second housing section 30 that are pivotally coupled to each other at a pivot joint 32. Pivot joint 32 is located at second end 16 opposite first end 14 and handle 18. Pivot joint 32 includes a pivot pin 34 defining a pivot axis 35. First housing section 28 and second housing section 30 are coupled to each other via pivot pin 34. Pivot joint 32 and pivot pin 34 are centered on pivot axis 35. First housing section 28 and second housing section 30 are configured to rotate with respect to pivot axis 35 between a closed position and an opened position. In a specific embodiment, pivot pin 34 is a knurled press pin.

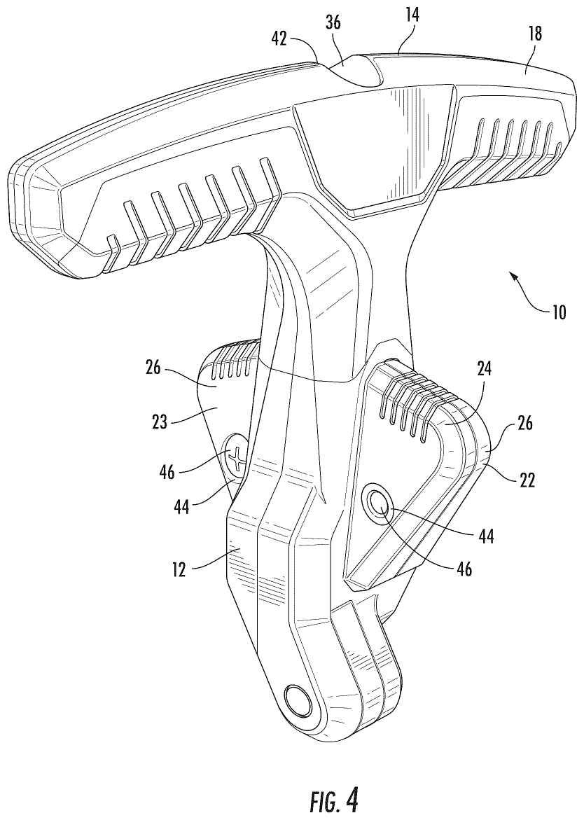

As shown in FIG. 3, cable slitter 10 includes a through-bore or through-hole 36. Through-hole is defined between first housing section 28 and second housing section 30. Through-hole 36 extends between first end 14 and second end 16 of housing 12 and defines a longitudinal axis 38. Through-hole 36 is centered on and extends along longitudinal axis 38. Housing 12 defines a lower opening 40 of through-hole 36 at second end 16 adjacent to pivot joint 32. As shown in FIG. 4, housing 12 also defines an upper opening 42 of through-hole 36 at first end 14 adjacent to handle 18. In this manner, through-hole 36 defines a bore that extends the entire length through housing 12 defining openings 40 and 42 at opposing ends of housing 12 along longitudinal axis 38. As shown, longitudinal axis 38 is oriented at a non-zero angle with respect to pivot axis 35. In the embodiment shown, pivot axis 35 is oriented in a direction substantially perpendicular to longitudinal axis 38. In a specific embodiment, longitudinal axis 38 is perpendicular to pivot axis 35. In another specific embodiment, when in the closed position, longitudinal axis 38 is skew to pivot axis 35 such that longitudinal axis 38 is not parallel to and does not intersect with pivot axis 35.

Blade housing 22 includes a bore 44 that receives fastener 46. As shown in FIGS. 4 and 5, respectively, in a specific embodiment, both blade housings 22 and 23 include bores 44 and fasteners 46 configured such that the fasteners 46 extend in opposite directions. First blade housing shell 24 and second blade housing shell 26 each include ridges along a top side to provide a surface that can easily be gripped by a user.

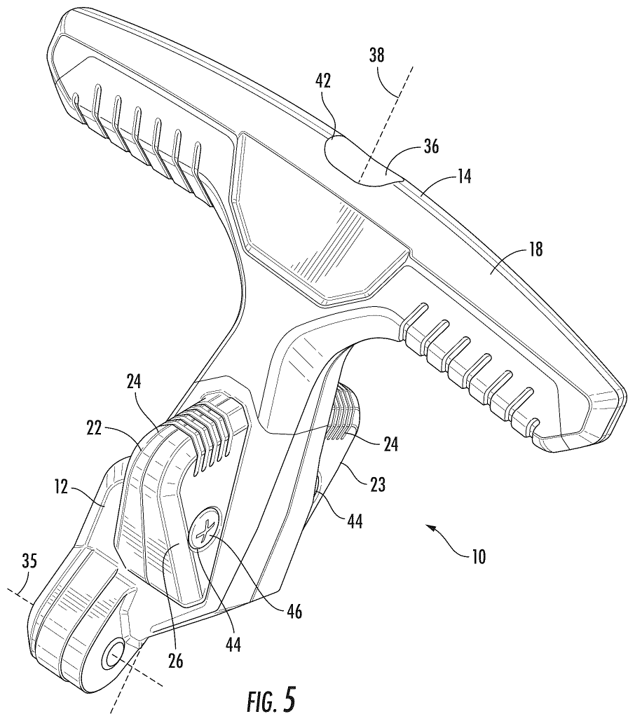

Referring to FIG. 6, pivot joint 32 includes a first pivot end protrusion 50, a second pivot end protrusion 52, and a central pivot protrusion 54. First pivot end protrusion 50 and second pivot end protrusion 52 extend from an end of first housing section 28. Central pivot protrusion 54 extends from an end of second housing section 30. Each of first pivot end protrusion 50, second pivot end protrusion 52, and central pivot protrusion 54 includes a pivot through-hole 56. When pivot joint 32 is assembled, pivot pin 34 extends through each pivot through-hole 56 of first pivot end protrusion 50, second pivot end protrusion 52, and central pivot protrusion 54 such that each pivot through-hole 56 is aligned with pivot axis 35. In a specific embodiment, first pivot end protrusion 50 and second pivot end protrusion 52 are integrally formed with first housing section 28 and central pivot protrusion 54 is integrally formed with second housing section 30.

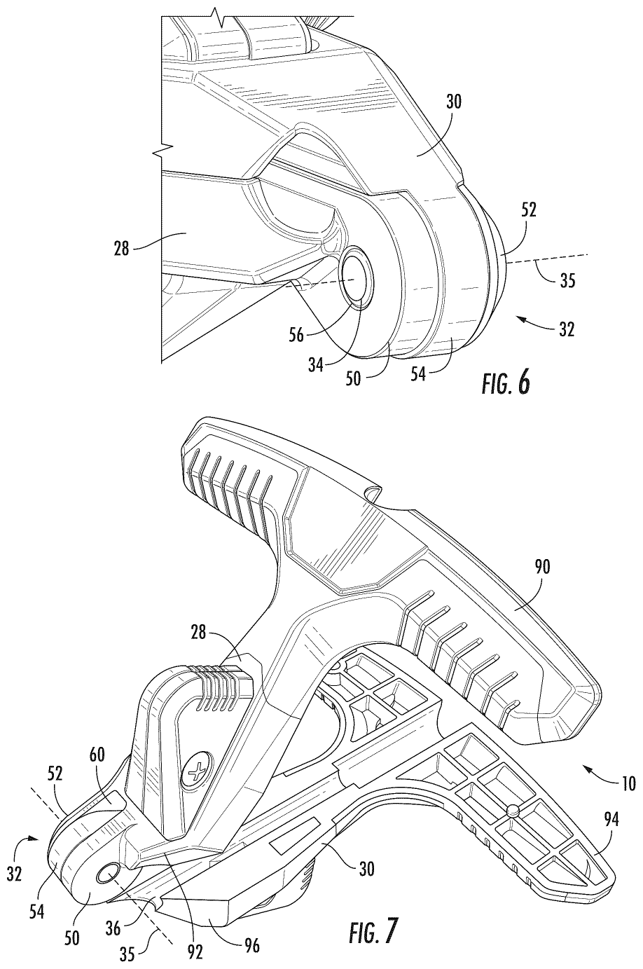

As shown in FIG. 7, first housing section 28 includes first end 90 and a second end 92 opposite first end 90. First pivot end protrusion 50 and second pivot end protrusion 52 extend from second end 92 of first housing section 28. Second housing section 30 includes a third end 94 and a fourth end 96 opposite third end 94. Central pivot protrusion 54 extends from fourth end 96 of second housing section 30. First pivot end protrusion 50 and second pivot end protrusion 52 define a slot or gap 60 configured to receive central pivot protrusion 54. First housing section 28 includes gap 60 between first pivot end protrusion 50 and second pivot end protrusion 52. Opening 42 of through-hole 36 is defined by first end 90 and third end 94, when in the closed position. Opening 40 of through-hole 36 is defined by second end 92 and fourth end 96, when in the closed position. Protrusion 54 is positioned along fourth end 96 such that it is offset from opening 40 and does not overlap with opening 40. Similarly, protrusions 50 and 52 are also offset from opening 40 and do not overlap with opening 40. As such, pivot joint 32 is offset from opening 40 and longitudinal axis 38.

Central pivot protrusion 54 is configured to fit within gap 60 when pivot joint 32 is assembled. First pivot end protrusion 50 and second pivot end protrusion 52 are pivotally coupled to central pivot protrusion 54 via pivot pin 34. In this way, pivot joint 32 is defined by protrusion 54, gap 60, and pivot pin 34. In a specific embodiment, first pivot end protrusion 50 and second pivot end protrusion 52 are pivotally coupled to central pivot protrusion 54 via a dual support press-fit such that central pivot protrusion 54 is supported on opposing sides by first pivot end protrusion 50 and second pivot end protrusion 52, respectively. This configuration allows for a secure connection between first housing section 28 and second housing section 30 at pivot joint 32 that can be offset entirely to one side of through-hole 36.

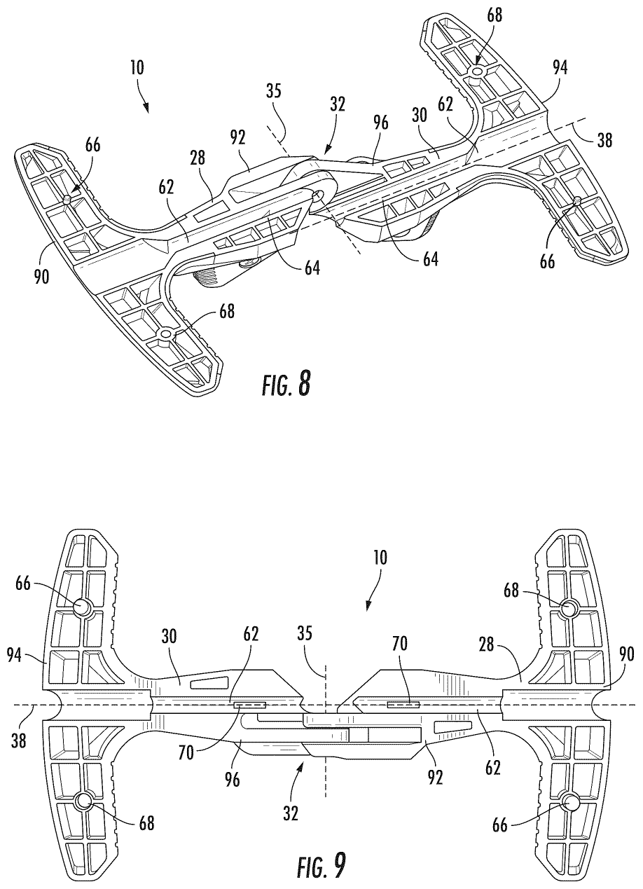

Cable slitter 10 is moveable between a closed position, shown in FIGS. 1-5, and an open position shown in FIGS. 8 and 9. When in the opened position, first housing section 28 is positioned at an angle with respect to second housing section 30. When in the closed position, first housing section 28 and second housing section 30 define through-hole 36 and is configured to cut a workpiece, such as a cable jacket, positioned within through-hole 36. To move cable slitter 10 between the open and closed positions, first housing section 28 and second housing section 30 rotate relative to each other about pivot axis 35. Pivot joint 32 is configured to function as a hinge such that opposing faces of first housing section 28 and second housing section 30 that are in contact when cable slitter 10 is in the closed position rotate directly toward or away from each other (e.g., in a plane substantially perpendicular to the opposing faces) and not at a slanted angle with respect to the opposing faces.

Referring to FIG. 8, a first recessed surface or first cable channel 62 extends along first housing section 28 from first end 90 to second end 92. A second recessed surface or second cable channel 62 extends along second housing section 30 from third end 94 to fourth end 96. First cable channel 62 and second cable channel 62 define through-hole 36 when cable slitter 10 is in the closed position. First housing section 28 and second housing section 30 each include cable channel 62 that extend in a direction parallel to longitudinal axis 38 when cable slitter 10 is in the closed position. The sides of housing 12 that form cable channels 62 define through-hole 36 when cable slitter 10 is in the closed position. As shown in FIG. 8, each of first housing section 28 and second housing section 30 include blades 64, a portion of blades 64 extending into cable channels 62. A first blade 64 is positioned between first end 90 and second end 92 of first housing section 28. A second blade 64 is positioned between third end 94 and fourth end 96 of second housing section 30. Referring to FIG. 9, each cable channel 62 includes a slot 70 configured to allow a portion of blades 64 to extend into cable channel 62.

First housing section 28 and second housing section 30 each include an alignment post 66 and an alignment hole 68. As shown, a first post 66 and a first alignment hole 68 are located at first end 90 of first housing section 28. A second post 66 and a second alignment hole 68 are located at third end 94 of second housing section 30. Each alignment post 66 corresponds to and aligns with an alignment hole 68 of the opposing housing section such that each alignment post 66 is releasably retained within an alignment hole 68 when cable slitter 10 is in the closed position. In a specific embodiment, alignment posts 66 include a ferromagnetic component, such as a steel insert. First housing section 28 and second housing section 30 include a magnet located in or around alignment holes 68. Alignment holes 68 are configured to magnetically retain alignment posts 66 such that cable slitter 10 is secured in the closed position.

First housing section 28 and second housing section 30 are configured to rotate about pivot axis 35 through an angle of 120 degrees or more with respect to each other. In a specific embodiment, first housing section 28 and second housing section 30 are configured to rotate about pivot axis 35 through an angle of 180 degrees or more with respect to each other. In a specific embodiment, when in the opened position an angle defined between first housing section 28 and second housing section 30 is at least 120 degrees. In another specific embodiment, when in the opened position an angle defined between first housing section 28 and second housing section 30 is at least 180 degrees.

Pivot joint 32 is offset and positioned entirely to one side of cable channels 62 such that the opposing side of cable channels 62 is accessible when cable slitter 10 is in the open position. The configuration of pivot joint 32 allows for a cable to be placed into one of cable channels 62 when cable slitter 10 is in the open position without feeding an end of the cable through cable channel 62. As such, cable slitter 10 is configured to accept cables from both an end of the cable or a mid-span location of the cable.

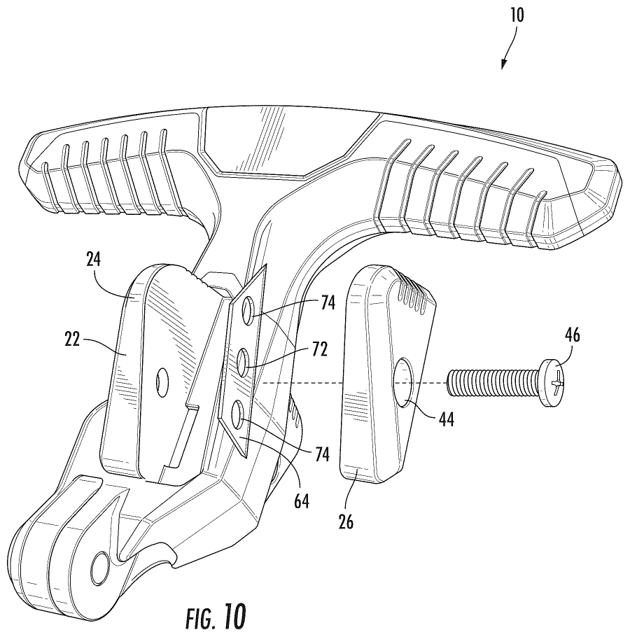

Referring to FIG. 10, an exploded view of blade housing 22 is shown, according to an exemplary embodiment. Blade 64 includes a central hole 72 configured to receive fastener 46. Central hole 72 aligns with bore 44 of blade housing 22 such that fastener 46 retains blade 64 within blade housing 22 between first blade housing shell 24 and second blade housing shell 26.

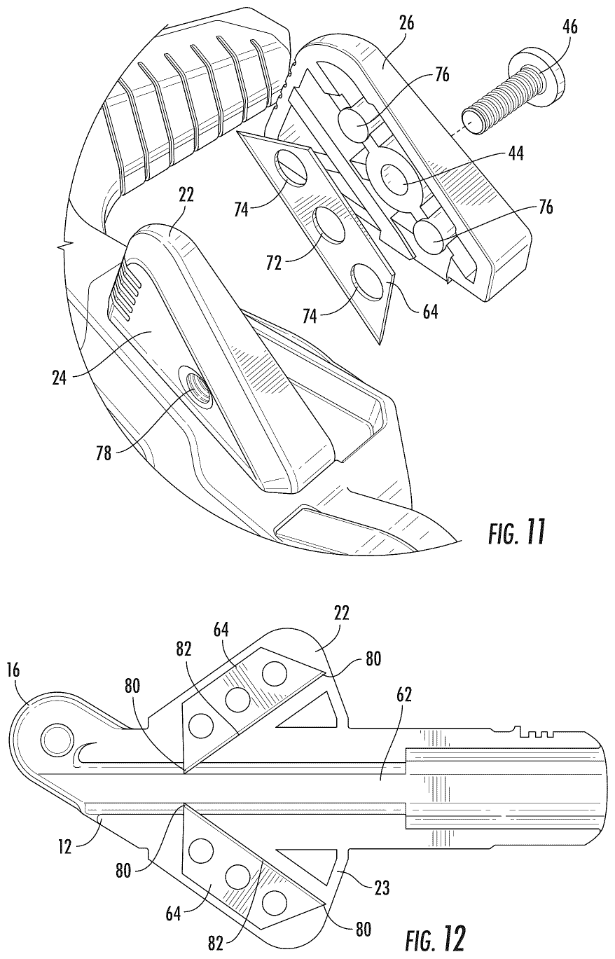

As shown in FIG. 11, blade 64 also includes offset holes 74 located on opposing sides of central hole 72. Second blade housing shell 26 includes a plurality of retaining protrusions 76. Retaining protrusions 76 are configured to pass through offset holes 74 to secure blades 64 within blade housing 22. Additional blades 64 can be stored within blade housing 22 by inverting the position of the additional blades 64 with respect to the blades 64 that partially extend into cable channel 62. First blade housing shell 24 includes a threaded portion 78, such as a threaded insert or nut, configured to interface with fastener 46.

As shown in FIG. 12, the opposing blade housings 22 and 23 each retain a blade 64 having pointed tips 80. One pointed tip 80 of blade 64 extends into cable channel 62 when blade 64 is retained in blade housing 22, while another pointed tip 80 is located within blade housing 22. Blades 64 are positioned within blade housing 22 such that no portion of blade 64 extends out of housing 12 or is exposed other than the portion of blade 64 that extends into cable channel 62. Each blade 64 includes a cutting edge 82 that is facing toward first end 14 of housing 12 and away from second end 16. Blades 64 are configured to be reversible such that each blade 64 can be reoriented to have either pointed tip 80 extend into cable channel 62. Either of blades 64 can be removed from blade housing 22 by a user and replaced with a new blade.

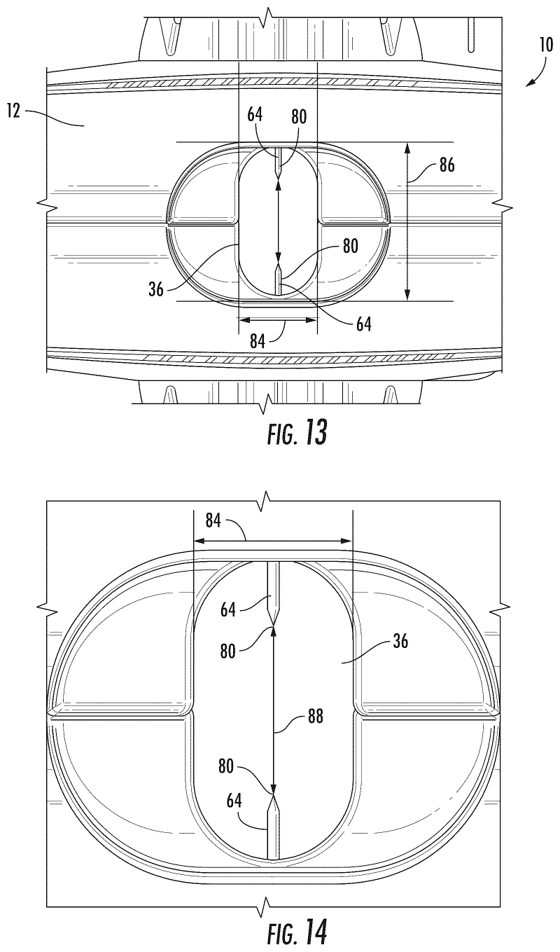

Referring to FIG. 13, a blade tip 80 extends from blade housing 22 through an inner surface of cable channel 62 of first housing section 28 and into through-hole 36. Another blade tip 80 extends from blade housing 38 through an inner surface of cable channel 62 of second housing section 30 and into through-hole 36. through-hole 36 has a width 84 measured in a direction perpendicular to longitudinal axis 38 and a height 86 measured in a direction perpendicular to longitudinal axis 38 and the direction from which width 84 is measured. In various embodiments, width 84 is between 2 mm and 10 mm, between 6 mm and 3 mm, between 4 mm and 5 mm, and/or about 4.65 mm. In various embodiments, height 86 is between 4 mm and 14 mm, between 12 mm and 6 mm, between 8 mm and 9 mm, and/or about 8.64 mm. In some embodiments, width 84 is less than 60% of height 86. The edges of housing 12 that define through-hole 36 include rounded corners. The geometry of through-hole 36 is configured to receive and retain fiber optic cables. In a specific embodiment, cable slitter 10 is configured to receive and slit cables having a width of between 0.155 in and 0.185 in and having a height of between 0.305 in and 0.350 in.

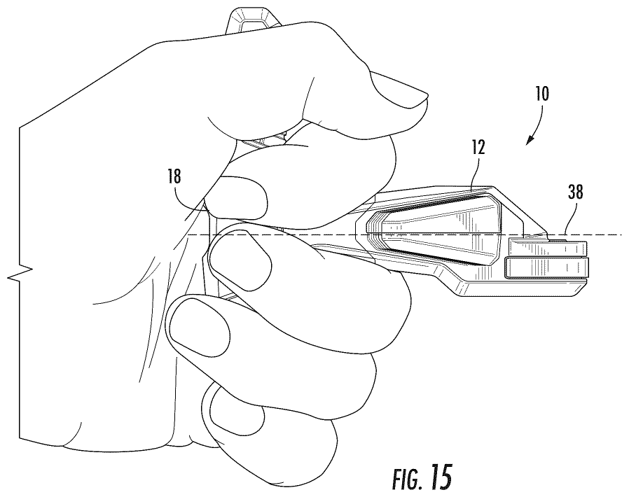

As shown in FIG. 14, blades 64 are placed centrally with respect to width 84. When cable slitter 10 is in the closed position, blades 64 are positioned on opposing sides of through-hole 36 such that blades 64 are configured to cut into and slit the sheath of cable that passes through through-hole 36 on opposite sides of the sheath. Pointed tips 80 of opposing blades 64 within through-hole 36 are spaced a distance 88 apart from one another. Distance 88 is sized such that blades 64 are positioned with enough space between opposing pointed tips 80 to slit the sheath of a cable with sufficient depth to slit the sheath from the cable while not damaging the wires or fibers within the sheath.

Cable slitter 10 is configured to receive, slit, and release a cable, such as a fiber optic cable. To slit a cable, the cable is placed into cable channel 62 of one of first housing section 28 or second housing section 30, while cable slitter 10 is in the open position. Cable slitter 10 is then adjusted into the closed position such that the cable is surrounded by housing 12 within through-hole 36. Blades 64 pierce or cut into a section of the sheath of the cable. As shown in FIG. 15, a user can then hold cable slitter 10 by handle 18 and drag or pull cable slitter 10 along a length of the cable in a direction parallel to longitudinal axis 38. As cable slitter 10 moves with respect to the cable, the sheath of the cable is slit on opposing sides (i.e., at two locations about 180 degrees away from each other along the perimeter of the cable sheath) such that the cable sheath can be pulled back or opened to reveal the fibers or wires within the cable.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A cutting tool for a cable jacket, comprising:
a housing, the housing comprising:
a first section defining a first recessed surface extending along the first section from a first end of the first section to a second end of the first section opposite the first end;
a second section defining a second recessed surface extending along the second section from a third end of the second section to a fourth end of the second section opposite the third end; and
a pivot joint coupling the first section to the second section, the pivot joint centered on a pivot axis, wherein the first section and the second section are rotatable with respect to the pivot axis between a closed position and an opened position;
wherein, when in the opened position, the first section is positioned at an angle with respect to the second section;
wherein when in the closed position the first recessed surface and the second recessed surface define a through-hole centered on and extending along a longitudinal axis;
wherein the pivot joint is offset to a side of the through-hole and the longitudinal axis is oriented at a non-zero angle with respect to the pivot axis; and
a blade tip positioned within the through-hole and configured to cut a cable jacket located within the through-hole.

2. The cutting tool of claim 1, wherein the longitudinal axis is oriented in a direction perpendicular to the pivot axis.

3. The cutting tool of claim 1, wherein, when in the closed position, the longitudinal axis is skew to the pivot axis.

4. The cutting tool of claim 1, wherein, when in the opened position, the angle defined between the first section and the second section is at least 120 degrees.

5. The cutting tool of claim 4, wherein the angle is at least 180 degrees.

6. The cutting tool of claim 1, wherein, when in the closed position, the first end of the first section and the third end of the second section define a first opening configured to receive a cable jacket.

7. The cutting tool of claim 1, wherein the first section of the housing comprises a post located at the first end, wherein the second section of the housing comprises a hole located at the third end and configured to receive and retain the post, and wherein the post is releasably retained within the hole when the housing is in the closed position.

8. The cutting tool of claim 7, wherein the post comprises a ferromagnetic component and the hole comprises a magnet.

9. A cable slitter, comprising:
a first section comprising a first end, a second end opposite the first end, a first blade positioned between the first end and the second end, and a slot defined in the second end;
a second section comprising a third end, a fourth end opposite the third end, a second blade positioned between the third end and the fourth end, and a protrusion extending away from the fourth end of the second section, wherein the protrusion is received within the slot of the first section and retained within the slot via a pivot pin defining a pivot axis; and
a through-hole defined between the first section and the second section, the through-hole extending along and centered on a longitudinal axis, the longitudinal axis oriented at a non-zero angle with respect to the pivot axis.

10. The cable slitter of claim 9, wherein the first section further comprises a first recessed surface extending from the first end to the second end, and the second section further comprises a second recessed surface extending from the third end to the fourth end, wherein the first recessed surface and the second recessed surface define the through-hole.

11. The cable slitter of claim 10, wherein the first recessed surface and the second recessed surface define an opening between the second end of the first section and the fourth end of the second section, wherein the opening is configured to receive a workpiece.

12. The cable slitter of claim 11, wherein the protrusion of the second section is positioned along fourth end such that it is offset from the opening and does not overlap with the opening.

13. The cable slitter of claim 9, wherein the longitudinal axis is oriented in a direction perpendicular to the pivot axis.

14. The cable slitter of claim 10, wherein the longitudinal axis is skew to the pivot axis.

15. The cable slitter of claim 9, wherein the first blade and the second blade are positioned on opposing sides of the through-hole and are configured to cut a workpiece positioned in the through-hole.

16. A cutting tool, comprising:
a first section comprising a first channel extending along the first section from a first end to a second end opposite the first end;
a second section comprising a second channel extending along the second section from a third end to a fourth end opposite the third end, the second section pivotally coupled to the first section via a pivot joint, the pivot joint centered on a pivot axis, wherein the first section and the second section are rotatable with respect to the pivot axis between a closed position and an opened position;
a through-hole defined by the first channel and the second channel when the first section and second section are in the closed position, the through-hole centered on and extending along a longitudinal axis, wherein the pivot axis is oriented in a direction perpendicular to the longitudinal axis; and
a blade tip extending through an inner surface of the through-hole and configured to cut a workpiece positioned in the through-hole.

17. The cutting tool of claim 16, wherein the pivot axis is skew to the longitudinal axis.

18. The cutting tool of claim 16, wherein the first section further comprises a slot defined in the second end, wherein the second section further comprises a protrusion extending away from the fourth end, and wherein pivot joint is defined by the protrusion, the slot, and a pivot pin coupling the protrusion to the second end of the first section.

19. The cutting tool of claim 16, wherein, when in the opened position, the first section is positioned at an angle with respect to the second section, and wherein the angle is at least 120 degrees.

20. The cutting tool of claim 16, wherein the first section comprises a post located at the first end, wherein the second section comprises a hole located at the third end and configured to receive and retain the post, and wherein the post is releasably retained within the hole when the first section and the second section are in the closed position.
